(19) United States
(12) Patent Application Publication
(10) Pub. No.: US 2025/0329972 A1
(43) Pub. Date: Oct. 23, 2025

(54) ELECTRICAL CONNECTOR SYSTEM

(71) Applicant: MJM Industries, Inc., Fairport Harbor, OH (US)

(72) Inventors: Joel Rozga, Leroy Township, OH (US); David J. Lemr, Fairport Harbor, OH (US); John Quirk, Madison, OH (US); Eric Wachob, Chardon, OH (US)

(73) Assignee: MJM Industries, Inc., Fairport Harbor, OH (US)

(21) Appl. No.: 19/182,733

(22) Filed: Apr. 18, 2025

Related U.S. Application Data
(60) Provisional application No. 63/635,723, filed on Apr. 18, 2024.

(51) Int. Cl. H01R 35/02

(52) U.S. Cl. CPC H01R 35/02

(57) ABSTRACT

A connector system, e.g., an electrical connector system for an assembly of one or more wires within a protective covering such as a cable, is provided. The connector system comprises an electronic encapsulation such as an overmolded component and a housing assembly that allows for several angles of indexing in relation to the mounting axis of the connector within this system. In at least one form, the housing assembly also allows for full 360-degree rotation of the connector head. Also, in at least one form, the housing assembly allows for both—several angles of indexing in relation to the mounting axis of the connector and a full 360-degree rotation of the connector head.

This application claims priority to and the benefit of U.S. provisional patent application Ser. No. 63/635,723, filed on Apr. 18, 2024, the disclosure of which is incorporated herein by reference in its entirety.

### TECHNICAL FIELD

The present exemplary embodiments relate to electrical connectors. They find particular application in conjunction with industrial automation and will be described with particular reference thereto. However, it is to be appreciated that the present exemplary embodiments are also amenable to other like applications.

### BACKGROUND

Some of the most popular connectors used in industrial automation are the M8 and M12 connectors. These connector families include a variety of different implementations for a variety of different environments; however, they typically have connecting diameters of 8 mm and 12 mm, respectively. Such connectors are considered to be among the most compact, affordable, and rugged connectors for many applications in industrial automation. Today, these connectors are offered in a variety of configurations, including panel mount, board mount, inline and field serviceable. One of the outstanding features of the M8/M12 connectors is their ability to provide sufficient ingress protection to levels of IP67/68/69.

For inline connectors, this level of ingress protection is typically achieved through an overmolding process that bonds and seals the connector body to the cable jacket. This overmolding process is typically implemented to achieve the required ingress protection, but unfortunately, a rigid overmold also limits some of the other functionalities and possible configurations within these connector families.

For inline type overmolded connectors, e.g., as shown in FIG. 1, they are typically offered in only two (2) mounting styles: a straight overmolded connector 10 and 90-degree overmolded connector 20. For simple connection to sensors or other individual devices, these two (2) mounting positions are often sufficient.

However, in many applications, e.g., as shown in FIG. 2, several of these connectors 30 are often connected to I/O distribution blocks 40 which will take the signals from several connectors 30 (such as M8 or M12 connectors) and manifold them to one independent cable (not shown) which is then connected to the host controller (not shown). Depending on how these connectors are aligned and mounted, and from where the independent cable assemblies originate, the two (2) available options for orientation are often not sufficient.

Having recognized this, some companies have developed slight iterations of the 90-degree connector by offering a 100-degree or 105-degree connector. Although this does offer some advantages over the conventional 90-degree connector, it does not always provide the best mounting solution and certainly provides no additional flexibility after it has been fabricated.

### BRIEF DESCRIPTION

In accordance with one aspect of the presently described embodiments, an apparatus comprises a wire assembly of one or more wires within a protective covering, the wire assembly having at least one end, a connector on the at least one end of the wire assembly and having a connector body, an over-molded component sealing a junction between the connector and the wire assembly, the over-molded component being bonded to the connector body and the protective covering defining a mating axis between the connector and the wire assembly, and a housing assembly including an adjustable portion to facilitate a bend to orient a portion of the wire assembly exiting the housing assembly at any of a plurality of angles relative to the mating axis.

In accordance with another aspect of the presently described embodiments, the protective covering is a tube.

In accordance with another aspect of the presently described embodiments, the wire assembly is a cable.

In accordance with another aspect of the presently described embodiments, the cable comprises one or more insulated wires.

In accordance with another aspect of the presently described embodiments, the protective covering comprises a cable jacket.

In accordance with another aspect of the presently described embodiments, the over-molded component includes at least one lug disposed around a circumference of the over-molded component.

In accordance with another aspect of the presently described embodiments, the lug is configured to allow 360-degrees rotation of the housing relative to the connector.

In accordance with another aspect of the presently described embodiments, the adjustable portion comprises an adjustable joint including extending portions through which rotation occurs to orient the portion of the cable exiting the housing at any of the plurality of angles relative to the mating axis.

In accordance with another aspect of the presently described embodiments, the adjustable portion comprises a revolute joint including cylindrical portions rotatable along angular faces of the cylindrical portions to orient the portion of the assembly exiting the housing at any of the plurality of angles relative to the mating axis.

In accordance with another aspect of the presently described embodiments, the housing assembly further comprises a locking mechanism to fix an angle relative to the mating axis.

In accordance with another aspect of the presently described embodiments, the plurality of angles span 90-degrees to 180-degrees inclusive.

In accordance with another aspect of the presently described embodiments, the connector has a connecting diameter of 8 mm.

In accordance with another aspect of the presently described embodiments, the connector has a connecting diameter of 12 mm.

In accordance with another aspect of the presently described embodiments, the connector has a connecting diameter of 16 mm.

In accordance with another aspect of the presently described embodiments, the connector has a connecting diameter of 23 mm.

In accordance with another aspect of the presently described embodiments, the connector has a connecting diameter of 5 mm.

In accordance with another aspect of the presently described embodiments, the connector is a D-sub connector, an RJ45 connector, a USB connector, a circular connector, a mil(military) spec connector or a moldable industrial electrical component connector.

In accordance with another aspect of the presently described embodiments, the connector is an electrical connector.

In accordance with another aspect of the presently described embodiments, an apparatus comprises a wire assembly of one or more wires within a protective covering, the wire assembly having at least one end, a connector on the at least one end of the wire assembly and having a connector body, an electronic encapsulation component sealing a junction between the connector and the wire assembly, the electronic encapsulation component being bonded to the connector body and the protective covering defining a mating axis between the connector and the wire assembly, and a housing assembly including an adjustable portion to facilitate a bend to orient a portion of the wire assembly exiting the housing assembly at any of a plurality of angles relative to the mating axis.

In accordance with another aspect of the presently described embodiments, the electronic encapsulation component comprises one of a molded component, a back-potted component, a hot-melt component, a thermoset component, or an epoxy back shell.

### BRIEF DESCRIPTION OF THE DRAWINGS

FIG. 1 is a depiction of conventional designs;

FIG. 2 is a depiction of a typical environment of implementation;

FIGS. 3A-3B are illustrations showing examples of the presently described embodiments;

FIG. 4 is an illustration showing an example of the presently described embodiments;

FIGS. 5A-5C are illustrations showing an example of the presently described embodiments;

FIGS. 6A-6C are illustrations showing an example of the presently described embodiments;

FIGS. 7A-7B are illustrations showing examples of the presently described embodiments;

FIGS. 8A-8C are illustrations showing an example of the presently described embodiments;

FIGS. 9A-9C are illustrations showing examples of implementations of the presently described embodiments; and,

FIGS. 10Ai-10Gii are illustrations showing an example of the presently described embodiments.

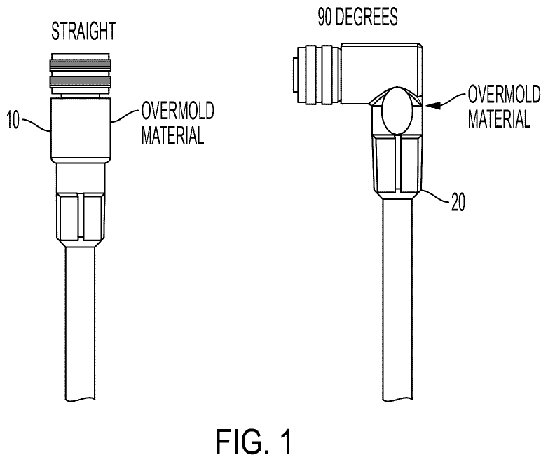

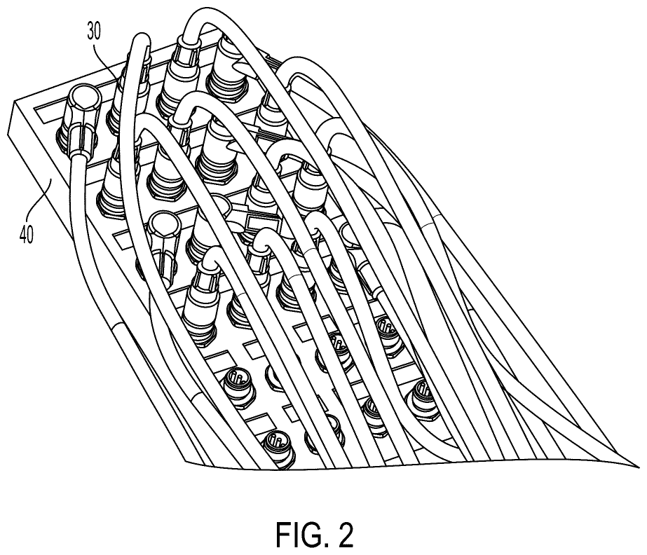

### DETAILED DESCRIPTION

The presently described embodiments relate, in at least one form, to a connector system, e.g., an electrical connector system for an assembly of one or more wires within a protective covering such as a cable, comprising an electronic encapsulation such as an overmolded component and a housing assembly that allows for several angles of indexing in relation to the mounting axis of the connector within this system. In at least one form, the housing assembly also allows for full 360-degree rotation of the connector head. Also, in at least one form, the housing assembly allows for both—several angles of indexing in relation to the mounting axis of the connector and a full 360-degree rotation of the connector head.

As an example, the presently described embodiments relate, in at least one form, to overmolded connectors for both M8 and M12 connector families that allow for the connector cable exit to be adjustable through a span of at least 90-degrees and, in some cases, at least 180-degrees and/or connector head to be rotated up to a full 360-degrees. As noted, these connector families include connectors for a variety of different implementations in a variety of different environments; however, they typically have connecting diameters of 8 mm (for the M8 connector family) and 12 mm (for the M12 connector family). This will allow for each connector to be custom fit in the field based upon the unique wiring parameters that are unique to each installation site/condition.

It should be appreciated that the presently described embodiments are not limited to M8 connectors and M12 connectors. Similar series of connectors exist, e.g., M16 connectors and M23 connectors. These families of connectors are typically larger versions of the M8 and M12 connectors. That is, their connection diameters are typically 16 and 23 mm, respectively. Likewise, smaller connectors, such as M5 connectors are available. These have connection diameters of approximately 5 mm. The presently described embodiments can also be applied to these various series of connectors as well.

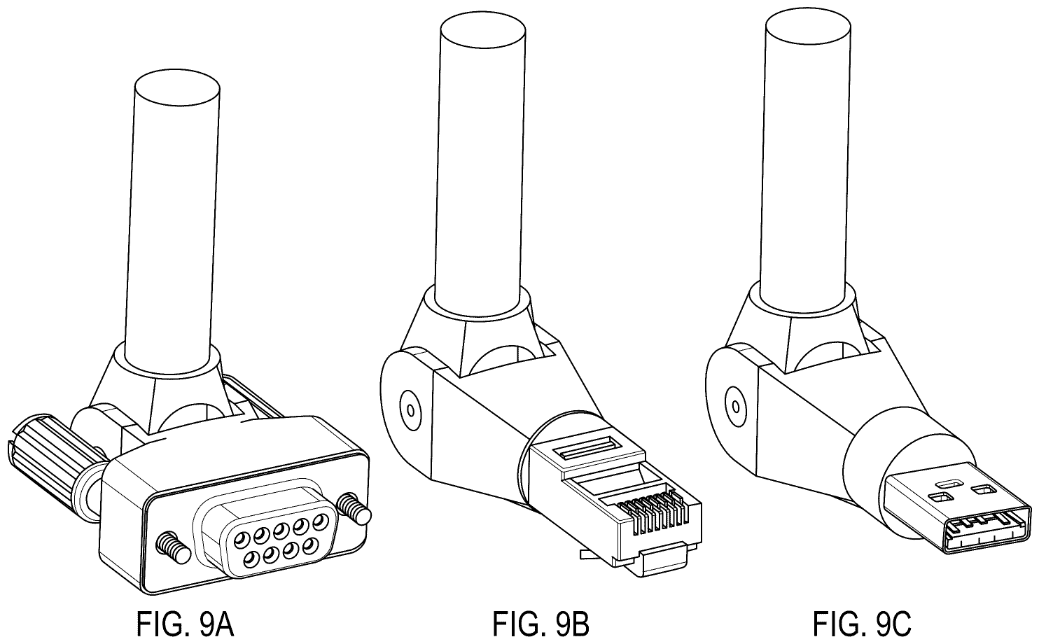

Of course, it is to be further appreciated that the presently described embodiments, in at least one form, may incorporate the noted multi-angled connector system into any overmolded electrical connector. For example, different sized connectors that are similar to those described above, and connector types such as D-sub (FIG. 9A), RJ45 (FIG. 9B), USB (universal serial bus) (FIG. 9C), mil (military) spec or any other circular connector, or other non-circular connector types such as moldable, industrial electrical component connectors, that could be overmolded, could implement the presently described embodiments.

The presently described embodiments may be implemented in a variety of forms and in a variety of environments. For example, the adjustability features noted above could be accomplished through a variety of mechanical methods and/or configurations. Non-limiting examples to achieve the presently described embodiments include implementations of any type of rotary or flexible union including various joints such as adjustable joints including, for example, revolute, knuckle, ball and socket, accordion style, telescoping, hook and detent, linear, hinge, swivel, and universal joints. It should also be appreciated that, in at least one form, the presently described embodiments achieve desired strain relief in connector system. That is, in at least some forms of the presently described embodiments, the noted multi-angled adjustability as well as strain relief between the cable and connectors are achieved.

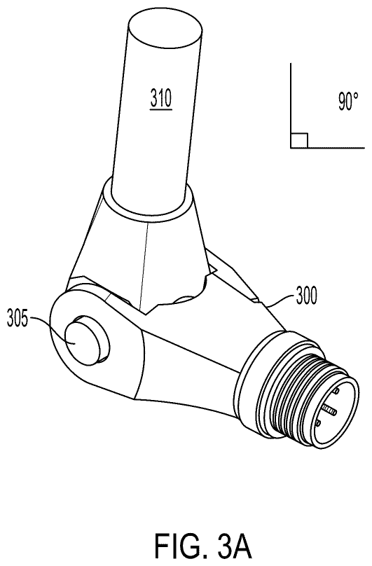

In this regard, as one example, with reference to FIGS. 3A-3B, a connector system 300 includes a housing assembly having, e.g., a revolute joint. The example revolute joint could take a variety of forms including a push button locked revolute joint having a push button mechanism 305. In these views, the cable 310 that is connected in the connector system 300 can be positioned at a variety of angles relative to, for example, a mating axis defined by an overmolded component or portion of the connector system bonded to the cable and a connector body. The relative position can be varied to suit the application, including 90° relative to the mating axis (FIG. 3A) and 180-degrees relative to the mating axis (FIG. 3B). In this regard, in at least one form, the connector system 300 comprises a housing assembly including an adjustable portion to facilitate a bend in the housing assembly and allow for free movement of the cable or assembly or wires to orient a portion of the cable, or assembly of wires, exiting the housing assembly at any of a plurality of angles relative to the mating axis. It should also be appreciated that, in at least one form, the relative angle can span at least 180-degrees, e.g., 90-degrees (as shown in FIG. 3A) to 180-degrees (as shown in FIG. 3B) to 270-degrees (or −90-degrees relative to the mating axis—not shown).

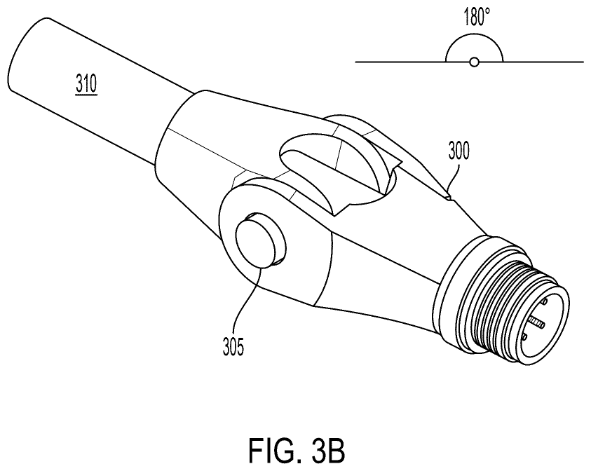

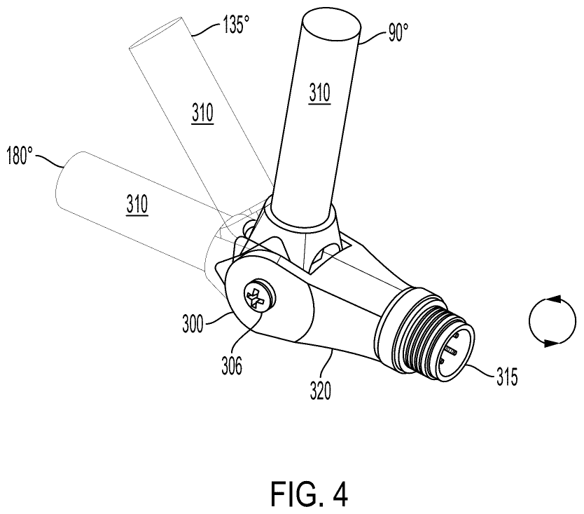

With reference to FIG. 4, the embodiment described in connection with FIGS. 3A and 3B is also optionally provided with 360-degrees rotation of the connector head 315 (e.g., an M-series connector head) within the housing element 320 of the connector system 300. Also, in FIG. 4, the connector system is modified from the embodiments shown in FIGS. 3A-3B. In this regard, a fastener 306 is provided in place of the push button mechanism 305 of the revolute joint in FIGS. 3A-3B. The fastener 306 may be loosened to allow rotation of the revolute joint through, for example, 90-degrees, with three example rotational positions, 180-degrees, 135-degrees, and 90-degrees, shown in FIG. 4. It will be appreciated that in at least one form, the fastener 306 can be tightened at any point through the arc of travel to lock the cable position. Also, as indicated above, rotation may occur through a span of at least 180-degrees, e.g., to 270-degrees (or −90-degrees relative to the mating axis).

It will be understood that a cable 310 is represented in FIG. 3A and FIG. 3B. However, the presently described embodiments could be used with other connectable structures, not just cables. In this regard, for example, any assembly of one or more wires, such as, e.g., insulated wires or uninsulated wires, within a protective covering, such as, e.g., a tube, jacket (e.g., a cable jacket), or other structure, having at least one end for connection, could be used with the presently described embodiments.

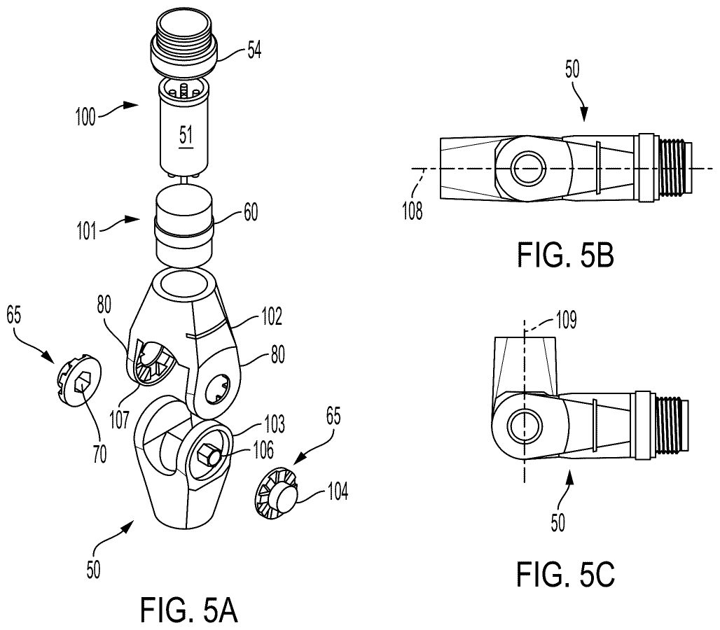

Referring now to FIGS. 5A-5C, an example implementation of the connector system 50 described thus far, such as the connector system of FIGS. 3A and 3B, will be described in greater detail. In this regard, the connector system 50 includes a connector 100 having a connector body 51 and coupling nut 54. In at least one form, the connector 100 is an industry standard industrial connector such as an M8 connector, M12 connector, or other connectors contemplated herein. An electronic encapsulation such as an overmolded component 101 will cover and seal the junction between the connector 100 and a connected cable (not shown). The overmolded component 101 will protect the connection from dust and water ingress. The overmolded component 101 also features an annular lug 60 that interfaces with a transition housing 102 of a housing assembly. This lug 60 retains the overmolded component 101 and connector 100 within the transition housing 102 and allows 360-degree rotation in line with a connector or mating axis. In this regard, in at least one form, the over-molded component 101 is bonded to the connector body 51 and a protective covering of the cable, defining the mating axis between the connector element 100 and the cable.

The transition housing 102 of the system houses the connector 100 and overmolded component 101 along with a first portion of a rotation and locking mechanism or cuts 107. The transition housing 102 also has two extensions 80 that hold a pivot housing 103 and allow it to sweep through at least a 90-degree arc. The transition housing 102 and the pivot housing 103 in combination with other noted components comprise a housing assembly according to the presently described embodiments.

The pivot housing 103 also holds second portions of the rotation and locking mechanism, e.g., locking plates 104 and boss 106. The pivot housing 103 is held by the transition housing 102 and can rotate through at least a 90-degree arc, shown from an orientation of 180 degrees at position 108 (FIG. 5B) to an orientation of 90 degrees at position 109 (FIG. 5C). The pivot housing 103 will direct the egress of the cable (not shown) from the overall system.

The locking plates 104 facilitate mechanical locking of the pivot housing 103 in relation to the transition housing 102. In at least one form, the locking plate 104 has multiple lugs 65 that fit into matching cuts 107 in the transition housing 102. The lugs 65 fit into the matching cuts 107 and lock the pivot housing 103 into multiple orientations between 180 and 90-degrees in relation to the main body 102. It should also be appreciated that, in at least one form, the relative angle can span at least 180-degrees, e.g., 90-degrees (as shown in FIG. 5C) to 180-degrees (as shown in FIG. 5B) to 270-degrees (or −90-degrees relative to the mating axis—not shown).

To disengage the locking plates 104, the user depresses both locking plates 104 by squeezing them together, e.g., using their fingers, a tool, or other suitable techniques. When the plates 104 are depressed, the pivot housing 103 can be rotated through its arc of movement. Once the pivot housing 103 is in the desired location, the user can release the locking plates 104. In this regard, springs (not shown) are suitably positioned and apply force on the locking plates 104 pushing the locking lugs 65 into the mating cuts 107 in the transition housing 102.

A hexagonal boss 106 on the pivot housing 103 keys into a hexagonal cut 70 on the back of the locking plates 104. This keeps the locking plates 104 in a fixed orientation in relation to the pivot housing 103. The locking cuts 107 in the main body provide a surface into which the locking plate lugs 65 are seated.

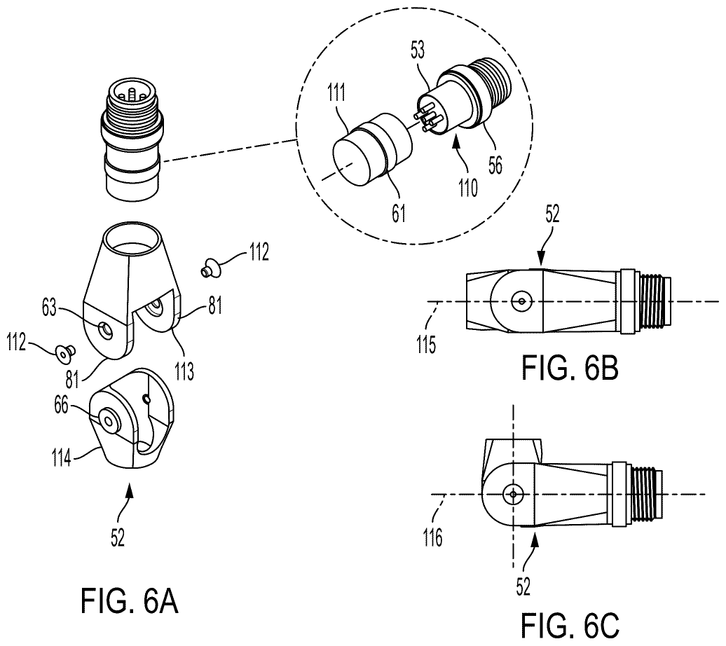

Another example configuration of the presently described embodiments, such as the example of FIG. 4, is shown FIGS. 6A-6C. In this regard, the connector system 52 includes a connector 110 having a connector body 53 and a coupling nut 56. In at least one form, the connector 110 is an industry standard industrial connector such as an M8 connector, M12 connector, or other connectors contemplated herein. An electronic encapsulation such as an overmolded component 111 will cover and seal the junction between the connector 110 and a connected cable (not shown). The overmolded component 111 will protect the connection from dust and water ingress. The overmolded component 111 also features an annular lug 61 that interfaces with a transition housing 113 of the connector system 52. This lug 61 retains the overmolded component 111 and connector 110 within the transition housing 113 and allows 360-degree rotation in line with the connector or mating axis. In this regard, in at least one form, the over-molded component 111 is bonded to the connector body 53 and a protective covering of the cable, defining the mating axis between the connector element and the cable.

As shown, screws 112 pass through holes 63 in the side of the transition housing 113 and thread into holes 66 in a pivot housing 114. The user can loosen the screws 112 to rotate the pivot housing 114 to the desired angle and tighten the screws to lock the pivot housing 114 to the transition housing 113.

The transition housing 113 houses the connector 110 and the overmold component 111. It also has two extensions 81 that allow for the pivot housing 114 to rotate through at least a 90-degree arc.

The pivot housing 114 determines the egress angle of the connector cable (not shown). The pivot housing 114 is held by the transition housing 113 and can rotate through at least a 90-degree arc, shown from an orientation of 180 degrees at position 115 (FIG. 6B) to an orientation of 90 degrees at position 116 (FIG. 6C). Again, the pivot housing 114 has two threaded holes 66 for the locking screws 112. Tightening the screws 112 will lock the pivot housing 114 to the main body 113. It should also be appreciated that, in at least one form, the relative angle can span at least 180-degrees, e.g., 90-degrees (as shown in FIG. 6C) to 180-degrees (as shown in FIG. 6B) to 270-degrees (or −90-degrees relative to the mating axis—not shown).

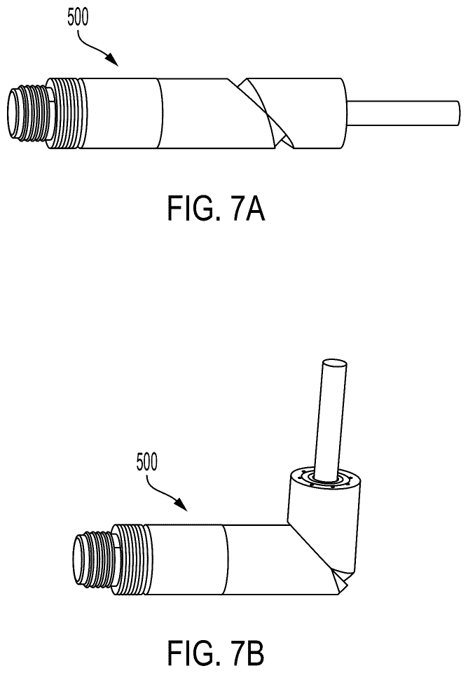

In another embodiment, with reference to FIGS. 7A and 7B, a hook and detent style connector is illustrated. As shown, a hook and detent style connector system 500 provides at least 180-degrees of cable rotation and 360-degrees of connector head rotation. The connector system 500 is capable of various relative angles, including a 180-degree angle relative to a mating axis (FIG. 7A) and a 90-degree angle relative to the mating axis (FIG. 7B). In this regard, in at least one form, the connector system 500 comprises a housing assembly including an adjustable portion to facilitate a bend in the housing assembly and allow for free movement of the cable or assembly of wires to orient a portion of the cable or assembly of wires exiting the housing assembly at any of a plurality of angles relative to the mating axis.

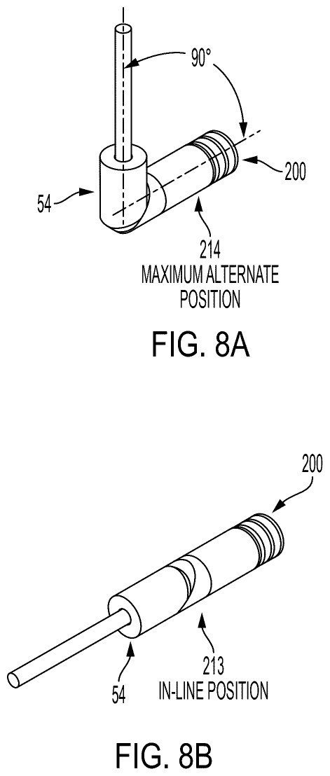

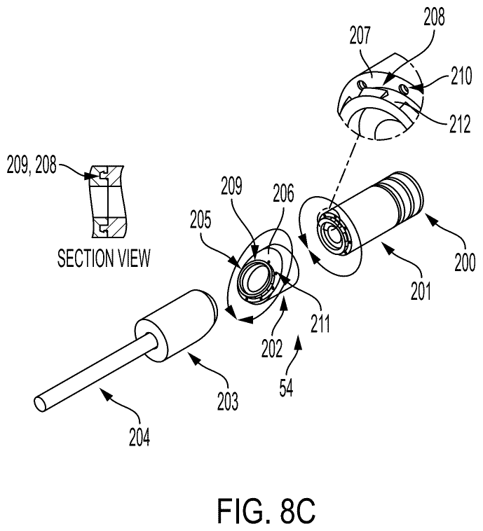

More specifically, referring to FIGS. 8A-8C, an example implementation is illustrated. As shown, a connector system 54 includes a connector 200 having a connector body. In at least one form, the connector 200 is an industry standard industrial connector such as an M8 connector, M12 connector, or other connectors contemplated herein. A primary overmolded component 201 will cover and seal the junction between the connector 200 and the connected cable 204. The primary overmolded component 201 will protect the connection from dust and water ingress. The primary overmolded component 201 also features an annular lug 212 that interlocks with a secondary molded component or housing 202 and allows 360-degree rotation in line with the connector or mating axis. In this regard, in at least one form, the over-molded component 201 is bonded to the connector 200 and a protective covering of the cable, defining the mating axis between the connector element and the cable.

In at least one form, the secondary molded component 202 interlocks with primary overmolded component 201, upon a surface 207 and the annular lug 212. It also interlocks with a tertiary molded component (or housing) 203, upon a surface 206 and an annular lug 205. It loosely encapsulates the cable 204 allowing for non-obstructed rotation about the axis of the system.

The tertiary molded component or housing 203 interlocks with the secondary component or housing 202, upon the surface 206 and the annular lug 205. It loosely encapsulates the cable 204 allowing for non-obstructed rotation about the axis of the system. It will be appreciated that the secondary molded component or housing 202 and the tertiary molded component or housing 203 comprise a housing assembly according to the presently described embodiments.

Male hook features 208 and 209 are molded into parts 201 and 202. Female latch features are molded into parts 202 & 203. This snap-together system locks the two mating parts together while allowing for 360-degree axial rotation upon mating surfaces 206 and 207.

In at least one form, female indent features 210 and 211 are molded into parts 201 and 202. Male post features (not shown) are molded into parts 202 and 203. This indexing system allows the mated connectors to snap into specific desirable positions about the axis of the components and locks them into a preferred location. It should be appreciated that features 210 and 211 (and the corresponding male post features) are optional. If not used, the components can freely rotate 360-degree about the components' concentric axis.

Similar to the orientation shown in FIG. 7A, a 180-degree orientation is shown at 213 (FIG. 8B). As in FIG. 7B, a maximum deflection of 90-degrees is shown at 214 (FIG. 8A).

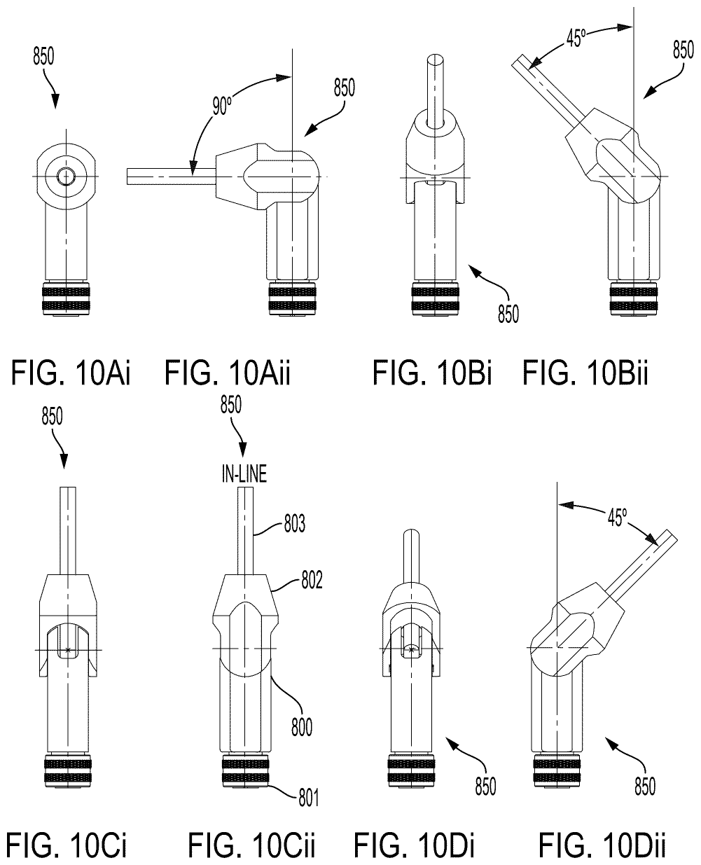

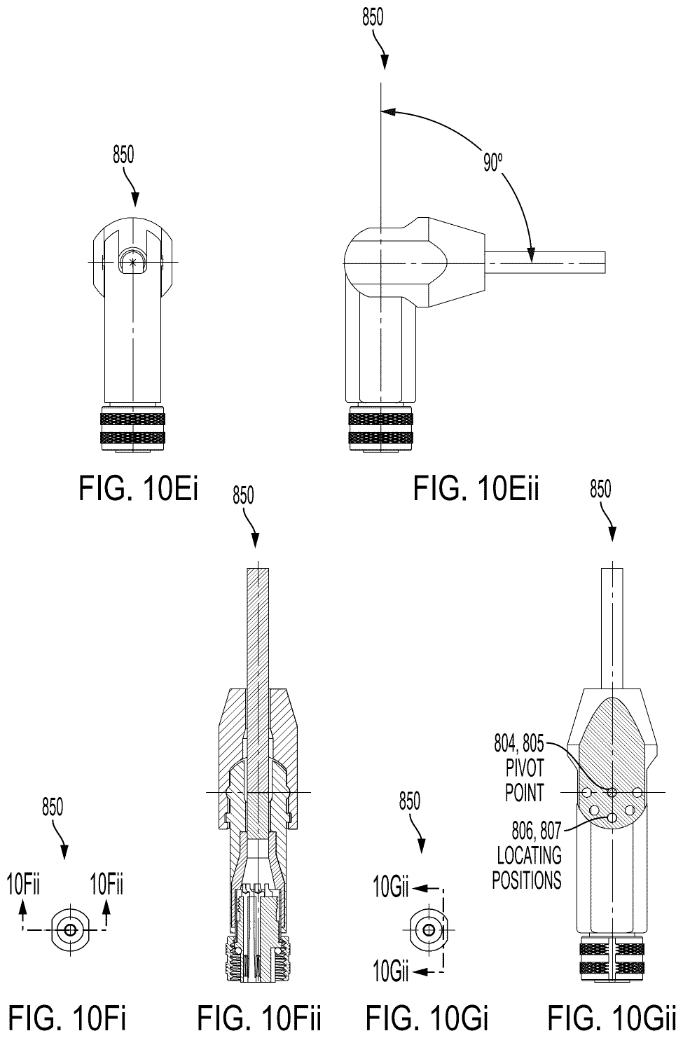

In another embodiment, with reference to FIGS. 10Ai-10Gii, a revolute joint style connector is illustrated. As shown, a revolute joint style connector system 850 provides up to 180-degrees of cable rotation. The connector system 850 is capable of various relative angles, including a bi-directional 90-degree angle relative to a mating axis (FIG. 10Ai through FIG. 10Eii). In this regard, in at least one form, the connector system 850 comprises a housing assembly including an adjustable portion to facilitate a bend in the cable or assembly of wires to orient a portion of the cable or assembly of wires exiting the housing at any of a plurality of angles relative to the mating axis.

More specifically, referring to FIGS. 10Ai-10Gii, examples of implementation are illustrated. As shown in FIG. 10Cii, a connector system 850 includes a connector 801 having a connector body. In at least one form, the connector 801 is an industry standard industrial connector such as an M8 connector, M12 connector, or other connectors contemplated herein. A primary overmolded component 800 will cover and seal the junction between the connector 801 and the connected cable 803. The primary overmolded component 800 will protect the connection from dust and water ingress. The primary overmolded component 800 may be formed in a variety of different ways and take a variety of different forms. For example, it may be a component formed from a single overmold process or, as shown in FIG. 10Fii, be the result of multiple (e.g., two) overmold processes (as shown by the portions in cross-section). Depending on the configuration, it may also serve as part of or complementary to a housing or housing assembly. The primary overmolded component 800 also features a male revolute joint 804 that interlocks with a secondary molded component, or housing or housing assembly, 802 which features a female revolute joint 805. This allows 90-degree bi-directional rotation in line with the connector or mating axis upon mating surfaces. In this regard, in at least one form, the over-molded component 800 is bonded to the connector 801 and a protective covering of the cable, defining the mating axis between the connector element and the cable.

With reference to FIGS. 10Fi through 10Gii, in at least one form, the secondary molded component 802 interlocks with primary overmolded component 800, upon a revolute joint comprised of features 805 and 804, respectively. It loosely encapsulates the cable 803 allowing for non-obstructed rotation about the axis of the system and allow for free movement of the cable 803 to orient a portion of the cable 803 exiting the component 802 at any of a plurality of angles relative to the mating axis.

The revolute joint style connector system 850 contains annular male features that mate into the secondary molded component 802 which contains female features. Male features 806 are molded into part 800. Female features 807 are molded into part 802. This snap-together system locks the two mating parts together while allowing for 90-degree bi-directional axial rotation upon mating surfaces at pivot points 804 and 805.

Similar to the orientation shown in FIG. 10Ci and FIG. 10Cii, 45-degree orientations are shown at FIGS. 10Bi and 10Bii, and FIGS. 10Di and 10Dii. As shown in FIGS. 10Ai and 10Aii, and FIGS. 10Ei and 10Eii, a maximum bi-directional deflection of 90-degrees.

As noted above, the presently described embodiments also, in at least one form, allow for processing methods to achieve these example variations and others described or contemplated herein while maintaining a seal between the connector, e.g., a connector body, and the cable. In this regard, the presently described embodiments have been described in connection with an electronic encapsulation example technique of overmolding, for example, using or forming a molded component. However, other electronic encapsulation techniques could be used. For example, back-potting or potting could be used. As a further example, low pressure molding operations such as hot melt techniques could be used. As a still further example, techniques for forming epoxy back shells or thermoset components could be used.

The exemplary embodiments have been described with reference to example implementations. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An apparatus comprising:
a wire assembly of one or more wires within a protective covering, the wire assembly having at least one end;
a connector on the at least one end of the wire assembly and having a connector body;
an over-molded component sealing a junction between the connector and the wire assembly, the over-molded component being bonded to the connector body and the protective covering defining a mating axis between the connector and the wire assembly; and
a housing assembly including an adjustable portion to facilitate a bend to orient a portion of the wire assembly exiting the housing assembly at any of a plurality of angles relative to the mating axis.

2. The apparatus as set forth in claim 1 wherein the protective covering is a tube.

3. The apparatus as set forth in claim 1 wherein the wire assembly is a cable.

4. The apparatus as set forth in claim 3 wherein the cable comprises one or more insulated wires.

5. The apparatus as set forth in claim 3 wherein the protective covering comprises a cable jacket.

6. The apparatus as set forth in claim 1 wherein the over-molded component includes at least one lug disposed around a circumference of the over-molded component.

7. The apparatus as set forth in claim 6 wherein the lug is configured to allow 360-degrees rotation of the housing relative to the connector.

8. The apparatus as set forth in claim 1 wherein the adjustable portion comprises an adjustable joint including extending portions through which rotation occurs to orient the portion of the cable exiting the housing at any of the plurality of angles relative to the mating axis.

9. The apparatus as set forth in claim 1 wherein the adjustable portion comprises an adjustable joint including cylindrical portions rotatable along angular faces of the cylindrical portions to orient the portion of the assembly exiting the housing at any of the plurality of angles relative to the mating axis.

10. The apparatus as set forth in claim 1 wherein the housing assembly further comprises a locking mechanism to fix an angle relative to the mating axis.

11. The apparatus as set forth in claim 1 wherein the plurality of angles span 90-degrees to 180-degrees inclusive.

12. The apparatus as set forth in claim 1 wherein the connector has a connecting diameter of 8 mm.

13. The apparatus as set forth in claim 1 wherein the connector has a connecting diameter of 12 mm.

14. The apparatus as set forth in claim 1 wherein the connector has a connecting diameter of 16 mm.

15. The apparatus as set forth in claim 1 wherein the connector has a connecting diameter of 23 mm.

16. The apparatus as set forth in claim 1 wherein the connector has a connecting diameter of 5 mm.

17. The apparatus as set forth in claim 1 wherein the connector is a D-sub connector, an RJ45 connector, a USB connector, a circular connector, a mil (military) spec connector or a moldable industrial electrical connector.

18. The apparatus as set forth in claim 1 wherein the connector is an electrical connector.

19. An apparatus comprising:
a wire assembly of one or more wires within a protective covering, the wire assembly having at least one end;
a connector on the at least one end of the wire assembly and having a connector body;
an electronic encapsulation component sealing a junction between the connector and the wire assembly, the electronic encapsulation component being bonded to the connector body and the protective covering defining a mating axis between the connector and the wire assembly; and
a housing assembly including an adjustable portion to facilitate a bend to orient a portion of the wire assembly exiting the housing assembly at any of a plurality of angles relative to the mating axis.

20. The apparatus as set forth in claim 19 wherein the electronic encapsulation component comprises one of a molded component, a back-potted component, a hot-melt component, a thermoset component, or an epoxy back shell.
